(19) United States
(12) Patent Application Publication
(10) Pub. No.: US 2012/0103913 A1
(43) Pub. Date: May 3, 2012

(54) METHOD FOR REMOVING METALLIC IONS FROM CONTAMINATED WATER BY SORPTION ONTO MAGNETIC PARTICLES COATED WITH LIGANDS

(76) Inventors: Hiroaki Kiyoto, Chiba (JP); Arturo A. Keller, Santa Barbara, CA (US)

(21) Appl. No.: 13/284,474

(22) Filed: Oct. 28, 2011

Related U.S. Application Data
(60) Provisional application No. 61/408,402, filed on Oct. 29, 2010.

(51) Int. Cl. B01D 35/06; C07F 19/00; C07F 15/02; C07F 13/00; C07F 15/06; C07F 15/04; H01F 1/42; C07F 9/00

(52) U.S. Cl. 210/695; 252/62.51 R; 556/29; 556/42; 556/45; 556/146; 556/138; 546/2

(57) ABSTRACT

A magnetic ligand particle is provided that includes a metal-binding organic ligand attached to a magnetic particle. In some embodiments, the magnetic ligand particle does not include a polymer layer, a metal layer or a metalloid layer in contact with the magnetic particle and/or the ligand. The organic ligand can be EDTA in some embodiments. Methods of using the magnetic ligand particle to remove metal contaminants from a liquid or slurry are also provided.

### CROSS-REFERENCE TO RELATED APPLICATIONS

This application claims the benefit of Provisional Patent Application No. 61/408,402, filed on Oct. 29, 2010, which is incorporated by reference herein.

### BACKGROUND

1. Field of the Invention

The invention relates to compositions and methods for removing contaminants.

2. Related Art

Inorganic pollutants such as lead ions, cadmium ions and other metal ions contaminate groundwater, soil, sediment and industrial sites. The toxicity of inorganic pollutants makes removal of such substances of major importance. Novel and creative approaches to clean-up are therefore required.

### SUMMARY

In one aspect, a magnetic ligand particle is provided. The magnetic ligand particle includes a metal-binding organic ligand attached to a magnetic particle. In some embodiments, the magnetic ligand particle does not include a polymer layer, a metal layer or a metalloid layer, or a combination thereof, in contact with the magnetic particle and/or the ligand. In the magnetic ligand particle, the metal-binding organic ligand can be ethylenediaminetetraacetate (EDTA). The magnetic ligand particle can also include a porous metalloid matrix, wherein the metal-binding organic ligand is present on the matrix, in the matrix, or both on and in the matrix. The metal-binding organic ligand is some embodiments can be a chelating agent and/or is not a surfactant. The metal-binding organic ligand can be directly attached to the magnetic particle, by sorption for example, or indirectly attached to the magnetic particle, via a matrix for example.

In a related aspect, a method of removing a metal contaminant from a liquid or slurry is provided. The method includes: adding a plurality of any embodiment of the magnetic ligand particle to the contaminated liquid or slurry; binding the metal contaminant to the metal-binding organic ligand of the plurality of the magnetic ligand particle, and separating the bound metal contaminant from the liquid or slurry by applying a magnetic field to the plurality of the magnetic ligand particle. In some embodiments, the metal ligand particle can be reused, either by first removing the bound contaminant before reuse, or by reusing the metal ligand particle without removing the bound contaminant.

### BRIEF DESCRIPTION OF THE DRAWINGS

For a more complete understanding of the present invention, reference is now made to the following descriptions taken in conjunction with the accompanying drawing, in which:

FIG. 1 is a schematic drawing of a magnetic ligand particle;

FIG. 2 is a schematic drawing of a magnetic ligand particle that includes a mesoporous metalloid shell;

FIG. 3 is a graph showing cadmium removal efficiency as a function of magnetic ligand particle concentration;

FIG. 4 is a graph showing cadmium ion removal efficiency as a function of initial cadmium concentration, at a magnetic ligand loading rate of 1 g/L;

FIG. 5 is a graph showing cadmium removal efficiency as a function of pH, at an initial cadmium concentration of 5 ppm and a magnetic ligand loading of 1 g/L; and

FIG. 6 is a graph showing reusability of magnetic ligand particles.

### DETAILED DESCRIPTION

The magnetic ligand particle includes a metal-binding organic ligand attached to a magnetic particle. The magnetic particle can be a nano- to micron-sized particle. In some embodiments, a nanoparticle is a particle having at least one dimension that is less than or equal to 100 nanometers (nm), while a micron-sized particle is a particle having at least one dimension in that is less than or equal to 100 μm, but more than 100 nm.

Magnetic materials that can be used to prepare magnetic particles include, but are not limited to, ferromagnetic materials and superparamagnetic materials, particularly iron oxides (such as magnetite, maghemite), metals (such as Ni, Co, Fe), alloys (such as FePt, CoPt, FePd, CoPd, and other magnetic oxides and nitrides), compounds such as CoSeO₄, VOSe₂O₅, and Mn(C₄H₄O₄), and a combination thereof.

The metal-binding organic ligand can be, but is not limited to, EDTA, ethylenediaminetriacetate, diethylenetriamine, ethylenediamine, dimethylglyoximate, oxalate, isothiocyanate, acetonitrile, pyridine or a pyridine derivative, acetonitrile, glycinate, acetylacetonate, or an ionic surfactant that has multiple ionized sites, or a combination thereof. Examples of ionic surfactants include, but are not limited to, cetyl trimethylammonium bromide (CTAB), 3-(trimethoxysily)propyl-octadecyldimethyl-ammonium chloride (TPODAC), polyoxyethylene glycol octylphenol ethers such as Triton X-100, ammonium lauryl sulfate, sodium laureth sulfate, cetylpyridinium chloride, benzalkonium chloride, alkyl ether phosphate, and polyoxyethylene glycol alkyl ethers.

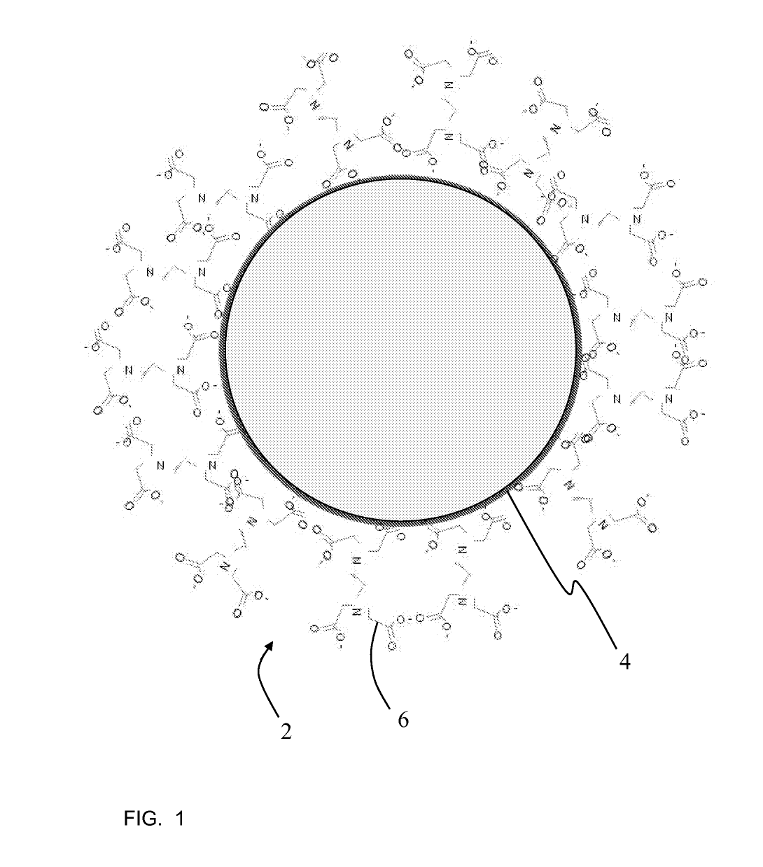

FIG. 1 illustrates an embodiment of a magnetic ligand particle 2 having a bare magnetic core 4 coated with a ligand 6, which is EDTA in the figure.

The magnetic ligand particle in some embodiments does not include a polymer layer, a metal layer or a metalloid layer. In these embodiments, the excluded polymer layer can be a layer of a synthetic polymer such as polyethylene or polypropylene, or a natural polymer such as protein, DNA, cellulose, or carbohydrate. The excluded metal layer can be a layer of titanium, gold, platinum, palladium, or other inert metals. The excluded metalloid layer can comprise silica, silicon, boron, selenium or germanium, or any mixtures thereof, including mixtures of these and other metalloids. In some embodiments, the metalloid layer is a metalloid matrix. The excluded polymer or metal layer or metalloid layer can be a porous layer, a coat, a support, a scaffold or a matrix. Also, in some embodiments, the metal-binding organic ligand is not from a biological source, and in some embodiments, the magnetic ligand particle does not comprise any material from a biological source. In some embodiments, the ligand is not a surfactant, and in some embodiments, the ligand is not in direct contact with any surfactant. Moreover, in some embodiments, the magnetic ligand particle does not include any surfactant.

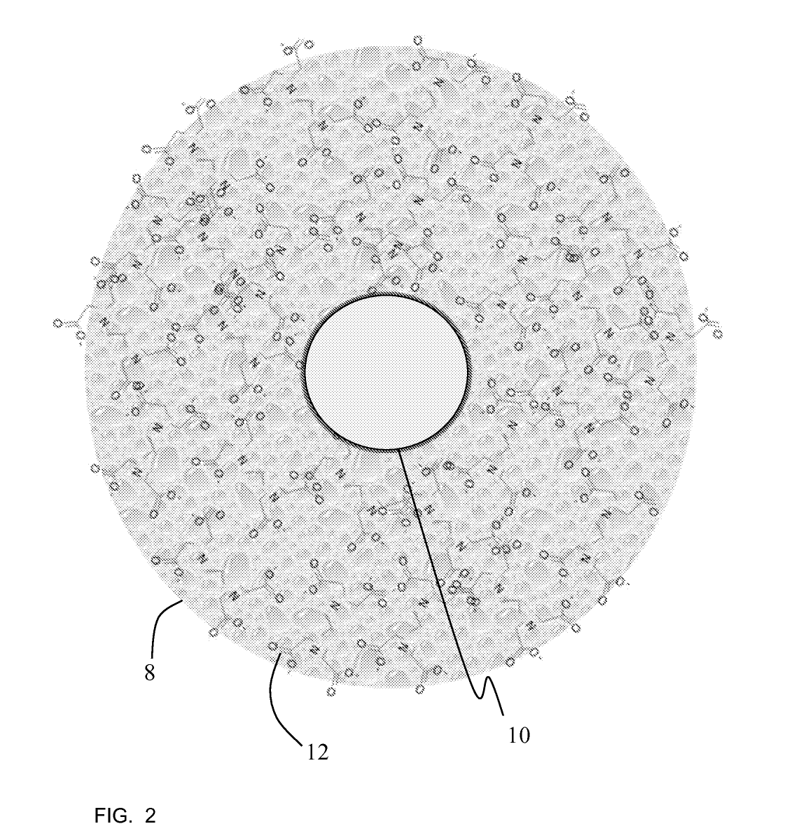

In certain embodiments, the magnetic ligand particle can include a porous metalloid matrix, where the metal-binding organic ligand is located on and/or confined in the matrix. In some of these embodiments, the metal-binding organic ligand is not a surfactant. However, a surfactant that binds the ligand can be included in the porous metalloid matrix. FIG. 2 shows an embodiment of a magnetic ligand particle that includes a mesoporous silica matrix in the form of a shell 8 surrounding a magnetic core 10. A surfactant is confined within the pores of the silica matrix and has affinity for a ligand 12, which is EDTA in the figure. As shown in FIG. 2, the ligand can be present at the surface of the porous silica matrix or within the porous silica matrix, or both. In some embodiments, the metalloid matrix can comprise silica, silicon, boron, selenium or germanium, or any mixtures thereof, including mixtures of these and other metalloids.

As an example, a typical synthesis of magnetic particles with the ligand bound in a porous silica matrix consists of four steps. First, superparamagnetic nano- or microparticles, such as Fe₃O₄, can be prepared via a solvothermal method as described before (Deng, Y.; Qi, D.; Deng, C.; Zhang, X.; Zhao, D. Superparamagnetic High-Magnetization Microspheres with an Fe₃O₄@SiO₂ Core and Perpendicularly Aligned Mesoporous SiO₂ Shell for Removal of Microcystins. J. Am. Chem. Soc. 2008, 130, 28-29; incorporated by reference herein). Briefly, 2.70 g of FeCl₃.6H₂O and 7.20 g of sodium acetate are dissolved in 100 ml of ethylene glycol. The obtained homogeneous solution is solvothermally heated at 200° C. for 8 h. Commercial superparamagnetic particles can also be used. Then the superparamagnetic particles can be treated to make the particle surface negatively charged, for example, using tetramethylammonium hydroxide (TMAOH). Briefly, 0.10 g of Fe₃O₄ particles (˜250 nm in diameter) are treated with 40 ml TMAOH solution (25 wt % solution in water) overnight. The TMAOH treated Fe₃O₄ particles are washed thoroughly with ethanol and then dispersed in a mixture of 60 ml ethanol and 10 ml deionized (DI) water. Next, the negatively charged superparamagnetic particles are placed in a solution of surfactant micelles (e.g., 3-(trimethoxysily)propyl-octadecyldimethyl-ammonium chloride or TPODAC, cetyl trimethylammonium bromide (CTAB), polyoxyethylene glycol octylphenol ethers such as Triton X-100, ammonium lauryl sulfate, sodium laureth sulfate, cetylpyridinium chloride, benzalkonium chloride, alkyl ether phosphate, or polyoxyethylene glycol alkyl ethers) and silica species (e.g. tetraethyl orthosilicate, TEOS). Briefly, the TMAOH treated Fe₃O₄ particles are washed thoroughly with ethanol and then dispersed in a mixture of 60 ml ethanol and 10 ml deionized (DI) water. During mechanical stirring, 0.24 ml of TPODAC (72%) is added, followed by the addition of 1.0 ml of ammonia aqueous solution (28 wt. %) and 0.22 ml of TEOS. After stirring at room temperature for 6 h, the Fe₃O₄@SiO₂-TPODAC particles are washed with ethanol thoroughly, dried at 60° C. for 12 h, and stored in a capped bottle prior to use. Finally, an organic ligand, such as EDTA, is adsorbed from an aqueous solution onto the TPODAC micelles within the mesoporous silica shell surrounding the superparamagnetic particles.

Examples of compounds for reversing surface charges of nanoparticles include tetramethylammonium hydroxide and other quaternary ammonium hydroxides.

In some embodiments, the organic ligand can be located on and/or in the porous metalloid or silica shell without including a surfactant.

In accordance herein, the magnetic ligand particle in some embodiments does not include a polymer layer, a metal layer, or a metalloid layer (such as a silica layer), or any combination thereof.

Some embodiments include a plurality of a magnetic ligand particle. In these embodiments, the plurality can be the only magnetic ligand particles present, or can be present with other magnetic ligand particles.

When used to remove metal contaminants from a liquid or slurry, a plurality of a magnetic ligand particle is added to the contaminated liquid or slurry. After allowing time for binding of the contaminants to the ligand, a magnetic field can be applied. The magnetic field attracts the magnetic ligand particles, which can then be separated from the liquid or slurry by, for example, pouring off the liquid or slurry, removing aliquots of the liquid or slurry, or removing the attracted magnetic particles from the liquid or slurry. The process of recovering the magnetic ligand particles can also be continuous, by first allowing the magnetic ligand particles to mix well with the contaminated liquid or slurry, such as within a reactor vessel, and then allowing the suspension to flow past a magnetic trap that continuously retains the magnetic ligand particles with the bound metal contaminants. The liquid or slurry can be water or an aqueous liquid. A magnetic field can be generated in ways well know in the art, such as by a permanent magnet, electromagnet, or alternating currents.

The metal contaminant can be a metal ion of cesium, cobalt, plutonium, mercury, cadmium, arsenic, lead, chromium, zinc, silver, nickel, cobalt, iron, or heavy metal pollutants generally. Moreover, depending on the ligand, some non-metal contaminants such as perchlorate, nitrate and cyanide may also be removed, as well as ionized or highly polar organic compounds such as ionized organic acids and bases, ionized pesticides and pharmaceutical compounds.

As described herein, magnetic nano- to micron-sized particles can be coated with an organic molecule that has high affinity for metal ions. These organic molecules are called ligands or chelating agents, and they bind strongly to target inorganic pollutants. One known ligand is EDTA (ethylenediaminetetraacetic acid). EDTA is approved for use as a food additive and in some medical applications, precisely for binding to metals. Other ligands can be used with the magnetic particles. The advantage of binding the ligand to a magnetic particle is that the particle can then be easily removed from treated water using a simple magnetic field. This eliminates the use of more complex filters or membranes to remove the ligand from solution. The magnetic ligand particles can be used until their capacity to bind the inorganic pollutants is reached. Once they are recovered using the magnetic field, the magnetic ligand particle can be treated with a solution, typically acidic, to remove the pollutants and thus regenerate almost all of the capacity to bind pollutants. The concentrated metal ions may be used for different applications, or the reduced volume can be disposed of safely.

In some embodiments, the ligand can be confined in a porous silica matrix attached to the magnetic nanoparticles. Because the ligand can bind strongly to the bare magnetic nanoparticle, however, the magnetic ligand particle can be prepared without a porous silica matrix, which could simplify manufacturing.

Applications for the magnetic ligand particles includes point-of-use treatment for residential or commercial users; treatment of water supplies at the municipal level or for larger facilities supplying water to many users; treatment of process water within various industrial activities where undesired metals and other inorganic pollutants may be present; and remediation of groundwater, soils and sediments that contain elevated levels of the target inorganic pollutants.

The present invention may be better understood by referring to the accompanying examples, which are intended for illustration purposes only and should not in any sense be construed as limiting the scope of the invention.

### Example 1

### Procedures and Results

Hematite nanoparticles (20-40 nm in diameter) were purchased from a commercial source. The hematite surface was activated using toluene and then 3-aminopropyltriethoxysilane in a reflux apparatus. After 2 hours, the heating was stopped and the dispersion was cooled to room temperature. Then the ligand EDTA and pyridine were added to the suspension and the suspension was refluxed for 2 hours at 45-50° C. The magnetic ligand particles were then washed with water and/or organic solvents to remove any residual ligand, with the final wash done with water. For example, sodium bicarbonate was added to the solution after refluxing, the solution was mixed, and the iron particles were collected with a magnet. The fluid was removed by decanting, and the particles washed twice with ethanol, twice with diethylether, and twice with distilled water. The particles were then collected using a magnet and dried for later use. The magnetic ligand particles in aqueous solution can also be used directly for treating water with metal ions, without drying. As described above, it is possible to also synthesize the magnetic ligand particles using a mesoporous matrix coating the magnetic hematite core, where the mesoporous matrix is typically composed of silica. In this case, the ligand may be permanently confined within the mesoporous matrix.

Experiments to test the removal efficiency of metal ions using the magnetic ligand particles were done with cadmium. For these experiments, the contaminated aqueous solution was prepared in the lab using cadmium salts at around 10 mg/L as cadmium ion. The magnetic ligand particles, based on EDTA as the ligand, were then added to the cadmium solution. Different amounts of magnetic ligand particles were evaluated. After allowing for equilibrium to be reached, the magnetic ligand particles were removed using a magnet. The remaining solution was then analyzed to determine the amount of cadmium ion remaining in solution. The results are presented in FIG. 3 for two batches of magnetic ligand particles, showing very good reproducibility of results.

### Example 2

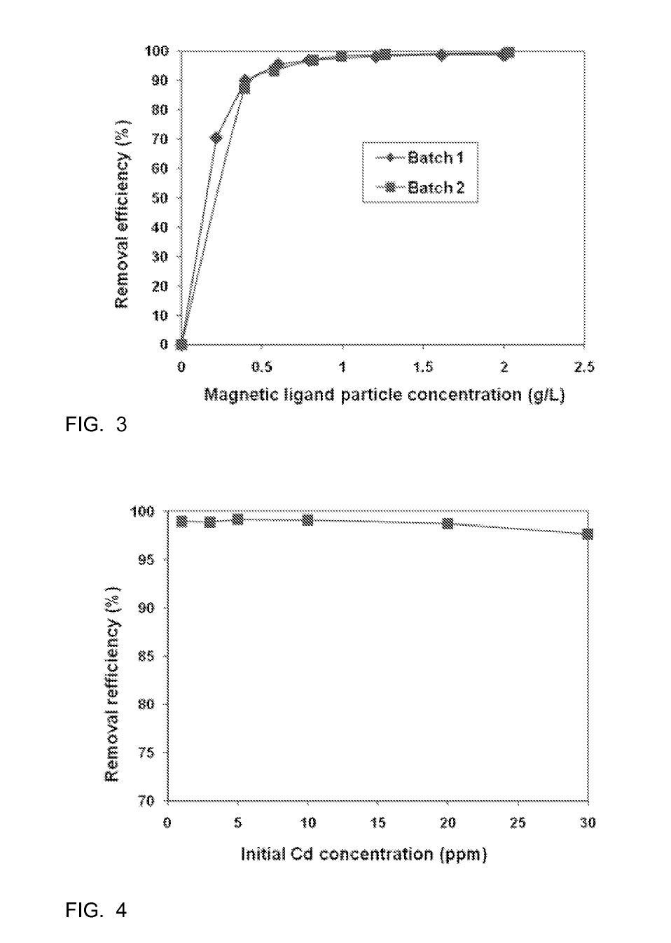

Additional experiments were conducted at different initial cadmium concentrations. The results presented in FIG. 4 indicate high removal efficiency for a range of initial cadmium ion concentrations, at a magnetic ligand loading of 1 mg/L.

### Example 3

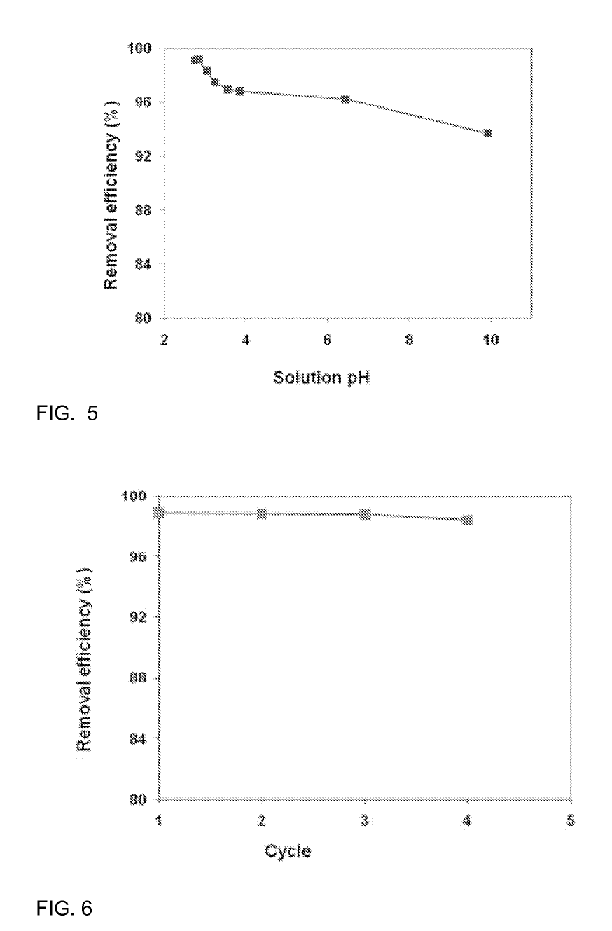

Removal efficiency is potentially a function of solution pH. Thus, experiments were conducted at different pHs. The highest removal efficiency of about 99.4% occurred at low pH, and steadily decreased as the pH increased to 6 (about 96% removal) and 10 (about 94% removal) (FIG. 5). Although pH had some effect on removal efficiency in these experiments, any decrease in removal efficiency due to pH could be compensated by increasing magnetic ligand particle loading.

### Example 4

A key advantage of the magnetic core is that it allows for very easy separation of the magnetic ligand particles from the treated solution. The particles can then be reused to treat more contaminated water. In the following experiments, the magnetic ligand particles were recovered using the magnet, washed with clean water, dried for 24 hours at room temperature, and then added to a new contaminated solution. FIG. 6 shows the result of the experiments to evaluate the reusability of the magnetic ligand particles. There is a small decrease in removal efficiency, but typically all the removal efficiencies are in the range of about 98 to 99.5%. In addition, a small amount of the initial mass of magnetic ligand particles was not recovered, which accounts to some extent for the decrease in removal efficiency.

### CONCLUSIONS

Nano and micron-sized particles with a magnetic core, based on hematite and other iron oxides in some embodiments, but extendable to any magnetic materials, can be coated with organic ligands, such as EDTA. In many instances, the ligand can firmly adhere to the magnetic particle due to electromagnetic interactions, although it is possible that a mesoporous matrix may be deposited on the magnetic particles to permanently confine the ligands. The mesoporous matrix can be made of silica or any other suitable material that forms a confining porous matrix. The magnetic ligand particles can then be used to remove metal ions, such as cadmium, from a contaminated solution. The removal efficiency is a function of magnetic ligand particle loading as well as initial metal ion concentration, so the ratio of these can be optimized to remove the metal ions at the highest removal efficiency. The removal efficiency is a weak function of solution pH, and therefore applicable under a wide range of conditions. The magnetic ligand particles can be easily regenerated using a simple wash with clean water, for reuse. The decrease in removal efficiency is small after several cycles of reuse. The magnetic ligand particles may also be able to remove many other ions from solution, including ionized or highly polar organic compounds.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the invention and the following claims.

What is claimed is:

1. A magnetic ligand particle comprising a metal-binding organic ligand attached to a magnetic particle, provided that the magnetic ligand particle does not include a polymer layer, metal layer or metalloid layer, or any combination thereof, in contact with the magnetic particle and/or the ligand.

2. The magnetic ligand particle of claim 1, wherein the magnetic particle is a nanoparticle or a micron-sized particle.

3. The magnetic ligand particle of claim 2, wherein the magnetic particle comprises magnetite, maghemite, Ni, Co, Fe, FePt, CoPt, FePd, CoPd, CoSeO₄, VOSe₂O₅, or Mn(C₄H₄O₄), or a combination thereof.

4. The magnetic ligand particle of claim 1, wherein the ligand is EDTA, ethylenediaminetriacetate, diethylenetriamine, ethylenediamine, dimethylglyoximate, oxalate, isothiocyanate, acetonitrile, pyridine or a pyridine derivative, acetonitrile, glycinate, acetylacetonate, or an ionic surfactant that has multiple ionized sites, or a combination thereof.

5. The magnetic ligand particle of claim 1, further comprising a porous metalloid matrix, wherein the ligand is present on and/or in the matrix, is a chelating agent, and is not a surfactant.

6. The magnetic ligand particle of claim 5, further comprising, in the porous metalloid matrix, a surfactant that binds the ligand.

7. The magnetic ligand particle of claim 6, wherein the porous metalloid matrix is a porous silica matrix.

8. A composition comprising a plurality of the magnetic ligand particle of claim 1.

9. A method of removing a metal contaminant from a liquid or slurry, comprising
adding a plurality of a magnetic ligand particle to a liquid or slurry comprising a metal contaminant, wherein the magnetic ligand particle comprises a metal-binding organic ligand attached to a magnetic particle, provided that the magnetic ligand particle does not include a polymer layer, metal layer or metalloid layer, or a combination thereof, in contact with the magnetic particle and/or the ligand;
binding the metal contaminant to the metal-binding organic ligand of the plurality of the magnetic ligand particle; and
separating the bound metal contaminant from the liquid or slurry by applying a magnetic field to the plurality of the magnetic ligand particle.

10. The method of claim 9, wherein the magnetic particle is a nanoparticle or a micron-sized particle.

11. The method of claim 10, wherein the magnetic particle comprises magnetite, maghemite, Ni, Co, Fe, FePt, CoPt, FePd, CoPd, CoSeO₄, VOSe₂O₅, or Mn(C₄H₄O₄), or a combination thereof.

12. The method of claim 9, wherein the ligand is EDTA, ethylenediaminetriacetate, diethylenetriamine, ethylenediamine, dimethylglyoximate, oxalate, isothiocyanate, acetonitrile, pyridine or a pyridine derivative, acetonitrile, glycinate, acetylacetonate, or an ionic surfactant that has multiple ionized sites, or a combination thereof.

13. The method of claim 9, wherein the magnetic ligand particle further comprises a porous metalloid matrix, wherein the ligand is present on and/or in the matrix, is a chelating agent, and is not a surfactant.

14. The method of claim 13, wherein the magnetic ligand particle further comprises, in the porous metalloid matrix, a surfactant that binds the ligand.

15. The method of claim 14, wherein the porous metalloid matrix is a porous silica matrix.

16. The method of claim 9, further comprising adding the separated plurality of the magnetic ligand particle to the same or another contaminated liquid or slurry without removing the bound metal contaminant from the separated plurality of the magnetic ligand particle.

17. The method of claim 9, further comprising treating the separated plurality of the magnetic ligand particle to remove the bound metal contaminant, then adding the treated plurality of the magnetic ligand particle to the same or another contaminated liquid or slurry.
